(19) United States
(12) Patent Application Publication
(10) Pub. No.: US 2009/0201065 A1
(43) Pub. Date: Aug. 13, 2009

(54) Local signal generation circuit

(75) Inventors: Akira Kuwano, Kanagawa (JP); Toshiyuki Tanaka, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/318,953

(22) Filed: Jan. 13, 2009

(30) Foreign Application Priority Data
Feb. 8, 2008 (JP) 2008-028383

(51) Int. Cl. G06F 1/04

(52) U.S. Cl. 327/299

(57) ABSTRACT

A local signal generation circuit in accordance with one aspect of the present invention includes a phase comparator that detects a phase difference between a reference signal and a feedback signal and outputs a error signal, a charge-pump circuit that receives the error signal and generates a step-up voltage, a loop filter that generates a tuning voltage by changing the shape of the step-up voltage, a voltage control oscillator that generates a first output signal having a predefined frequency based on the tuning voltage, and a prescaler that outputs a second output signal generated by dividing the frequency of the first output signal to a predefined frequency and also outputs a frequency-division signal generated by dividing the frequency of the first output signal to the predefined frequency to a frequency divider that generates the feedback signal.

### BACKGROUND

1. Field of the Invention

The present invention relates to a local signal generation circuit, in particular a local signal generation circuit having a variable frequency oscillator capable of changing the frequency of the output signal.

2. Description of Related Art

In devices adopting a communication mode based on the UWB (Ultra Wide Band) standard such as the wireless USB (Universal Serial Bus), communication is carried out by dividing a wide band signal (e.g., 3 GHz to 10 GHz) and using a portion of the wide band signal (i.e., a band group having three or two center frequencies). Furthermore, in a communication mode based on the UWB standard, the transmitter side and the receiver side use the same carrier frequency by sharing the carrier frequency in a time-division manner. Furthermore, when a direct conversion configuration is adopted, the device have a local signal generation circuit to generate a local signal having the same frequency as the carrier frequency, and the modulation of a transmit signal or the demodulation of a receive signal is carried out by the local signal.

Therefore, it is required that the local signal generation circuit should be able to generate a wide band signal with high precision. In the local signal generation circuit, a PLL (Phase Locked Loop) circuit using a voltage control oscillator is used. However, it is generally difficult to generate a wide band signal (e.g., to generate a signal having low phase noise) with a single PLL circuit with high precision. Accordingly, a technique to generate a wide band signal with high precision is disclosed in Hiroshi Komada et al., “Wide Lock-Range, Low Phase-Noise PLL using Interpolative Ring-VCO with Coarse Frequency Tuning and Frequency Lineariztion”, IEEE 2007 Custom Integrated Circuits Conference (CICC), pp 349-352.

FIG. 9 is a block diagram of a PLL circuit 100 disclosed in Hiroshi Komada et al., “Wide Lock-Range, Low Phase-Noise PLL using Interpolative Ring-VCO with Coarse Frequency Tuning and Frequency Lineariztion”, IEEE 2007 Custom Integrated Circuits Conference (CICC), pp 349-352. As shown in FIG. 9, the PLL circuit 100 constitutes a PLL loop by a phase comparator PFD, a charge-pump circuit CP, a loop filter composed of capacitors and a resistor, a voltage control oscillator (Ring-VCO in the figure), frequency dividers 102 and 103, and a selector 104. Then, it generates an output signal FOUT by multiplying a reference signal FREF by a factor corresponding to the frequency-division ratios of the frequency dividers 102 and 103. Furthermore, the PLL circuit 100 also includes a frequency divider 101 that is arranged outside of the PLL loop and divides the frequency of the output signal on the Q-side by two, and a selector 105 that selects either one of the output signal from the PLL loop and the output signal from the frequency divider 101. That is, the PLL circuit 100 generates a signal in a low-frequency band by the frequency divider 101, and selects either one of the signal on the high-frequency side and the signal on the low-frequency side as the signal to be output. In this way, it becomes possible in the PLL circuit 100 to output a relatively wide band signal for the PLL circuit 100, while restricting the frequency band of the signal generated by the PLL loop. Note that the PLL circuit 100 controls the frequency of the signal generated by the PLL loop by a loop frequency adjust signal, a frequency setting and linearity control signal, and a module control signal.

### SUMMARY

However, the present inventors have found that the following problem. Since the frequency divider 101 has to be arranged outside of the PLL loop in the PLL circuit 100, there is a problem that the circuit area and the power consumption increase. Since strict restrictions are imposed on the size of circuit areas and the amount of power consumption in mobile devices and the likes, the increase in the circuit areas and the power consumption becomes a serious problem.

A first exemplary aspect of an embodiment of the present invention is a local signal generation circuit including: a phase comparator that detects a phase difference between a reference signal and a feedback signal and outputs a error signal; a charge-pump circuit that receives the error signal and generates a step-up voltage; a loop filter that generates a tuning voltage by changing the shape of the step-up voltage; a voltage control oscillator that generates a first output signal having a predefined frequency based on the tuning voltage; and a prescaler that outputs a second output signal generated by dividing the frequency of the first output signal to a predefined frequency and also outputs a frequency-division signal generated by dividing the frequency of the first output signal to the predefined frequency to a frequency divider, the frequency divider generating the feedback signal.

A local signal generation circuit in accordance with one aspect of the present invention outputs a frequency-division signal by a prescaler that constitutes a part of a PLL loop. In this way, it is unnecessary to provide an additional frequency divider to generate the frequency-division signal. Therefore, a local signal generation circuit in accordance with one aspect of the present invention can reduce the circuit area and the power consumption.

A local signal generation circuit in accordance with one aspect of the present invention can control the frequency of the output signal with high precision, while reducing the circuit area and the power consumption.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a transmitter-receiver apparatus in accordance with an exemplary embodiment of the present invention;

FIG. 2 is a schematic diagram of radio signals handled in a transmitter-receiver apparatus in accordance with an exemplary embodiment of the present invention;

FIG. 3 is a block diagram of a local signal generation circuit in accordance with an exemplary embodiment of the present invention;

FIG. 4 is a block diagram of a voltage control oscillator in accordance with an exemplary embodiment of the present invention;

FIG. 5 is a diagram showing the waveforms of the output signals of a voltage control oscillator in accordance with an exemplary embodiment of the present invention;

FIG. 6 is a circuit diagram of a voltage control oscillator in accordance with an exemplary embodiment of the present invention;

FIG. 7 is a block diagram of a prescaler in accordance with an exemplary embodiment of the present invention;

FIG. 8 is a diagram showing the waveforms of the input and output signals of a prescaler in accordance with an exemplary embodiment of the present invention; and

FIG. 9 is a block diagram of a local signal generation circuit in the related art.

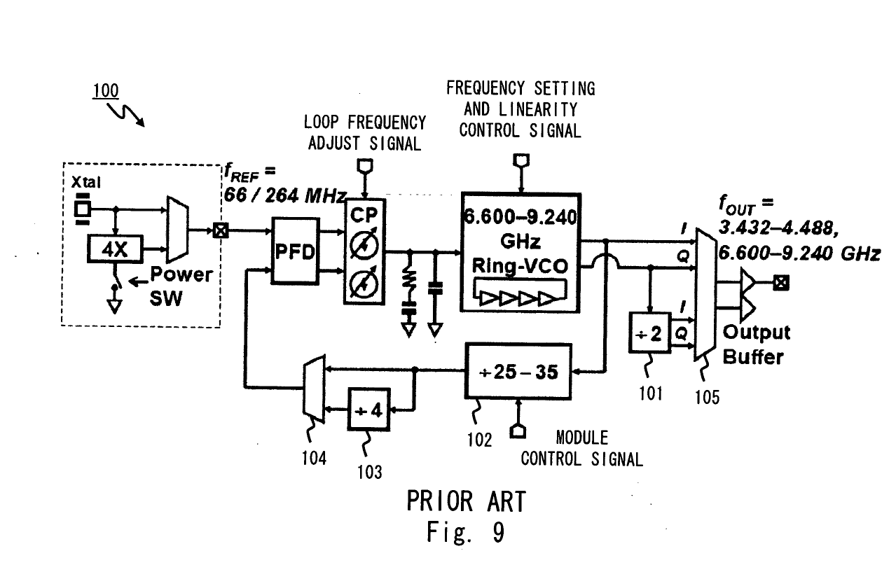

### DETAILED DESCRIPTION OF THE EXEMPLARY EMBODIMENTS

### First Exemplary Embodiment

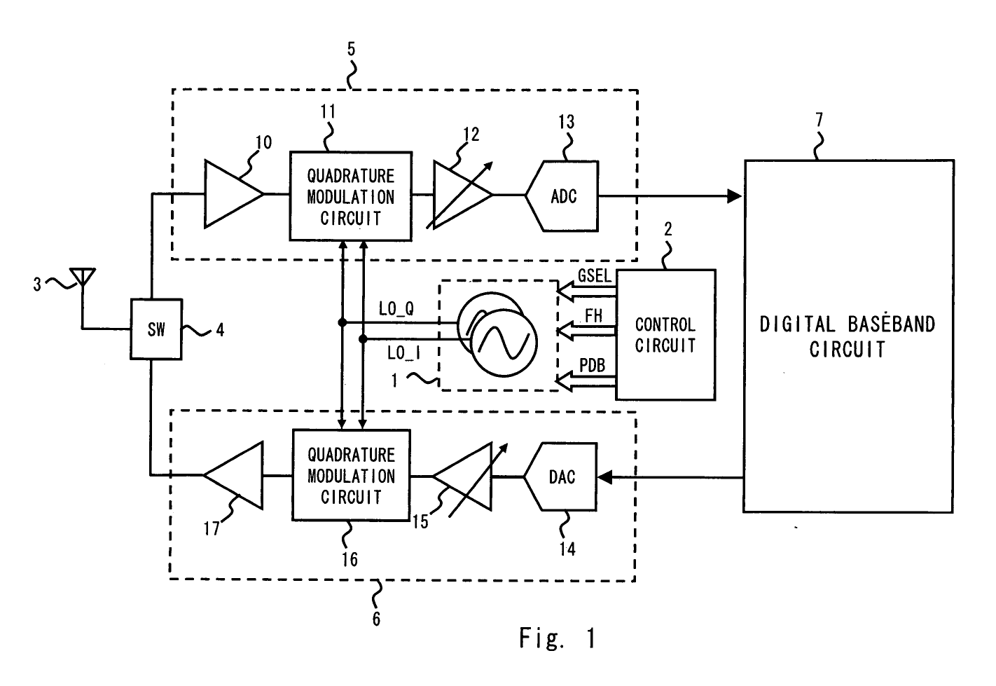

Exemplary embodiments of the present invention are explained hereinafter with reference to the drawings. FIG. 1 is a block diagram of a transmitter-receiver apparatus having a local signal generation circuit 1 in accordance with an exemplary embodiment of the present invention. As shown in FIG. 1, the transmitter-receiver apparatus includes a local signal generation circuit 1, a control circuit 2, an antenna 3, a switching circuit 4, a receiving circuit 5, a transmitting circuit 6, and a digital baseband circuit 7.

The local signal generation circuit 1 generates output signals (hereinafter called “local signals”) LO_I and LO_Q. Each of the local signals LO_I and LO_Q is a differential signal, and their phases are different by 90 degrees from each other. That is, the local signals include four signals whose phases are different by 90 degrees from one to another.

The control circuit 2 generates a band group select signal GSEL, a hopping control signal FH, and a PLL control signal PDB. The band group select signal GSEL indicates the frequency band of an output signal generated by the local signal generation circuit 1. The hopping control signal FH indicates switching timing of the output of the local signal generation circuit 1 in accordance with a hopping pattern that indicates a switching pattern of the output signal generated by the local signal generation circuit 1. The PLL control signal PDB indicates the operating state and the non-operating state for each PLL circuit within the local signal generation circuit.

The antenna 3 transmits and receives a radio signal. The switching circuit changes the signal path between in a receiving state and in a transmitting state. For example, the switching circuit 4 connects the antenna 3 to the receiving circuit 5 in the receiving state, and connects the antenna 3 to the transmitting circuit 6 in the transmitting state.

The receiving circuit 5 includes a low noise amplification circuit 10, a quadrature modulation circuit 11, a receiving-side variable amplification circuit 12, and an analog-digital conversion circuit 13. The low noise amplification circuit 10 amplifies a signal input through the antenna 3 and the switching circuit 4. The quadrature modulation circuit 11 demodulates the output signal of the low noise amplification circuit 10 by using the local signals LO_I and LO_Q, and generates a demodulated signal. The receiving-side variable amplification circuit 12 amplifies the demodulated signal such that the demodulated signal has a predetermined amplitude after the amplification. The analog-digital conversion circuit 13 converts the demodulated signal (analog signal) that is also amplified by the receiving-side variable amplification circuit 12 to a digital signal.

In the receiving state, the digital baseband circuit 7 carries out processes such as a decoding process on the digital signal output by the analog-digital conversion circuit 13 of the receiving circuit 5, and outputs a data signal obtained from the received signal to a processing circuit (not shown) at the subsequent stage. On the other hand, in the transmitting state, the digital baseband circuit 7 carries out processes such as a encoding process on a signal sent from a processing circuit at the preceding stage to generate a transmit data, and outputs the transmit data to the transmitting circuit 6.

The transmitting circuit 6 includes a digital-analog conversion circuit 14, a transmitting-side variable amplification circuit 15, a quadrature modulation circuit 16, and a transmission amplification circuit 17. The digital-analog conversion circuit 14 converts transmit data (digital signal) output from the digital baseband circuit 7 to an analog signal, and outputs the analog-converted transmit data to the transmitting-side variable amplification circuit 15. The transmitting-side variable amplification circuit 15 amplifies the amplitude of the analog-converted transmit data such that the radio signal output from the antenna 3 has a constant output power. The quadrature modulation circuit 16 modulates transmit data output from the transmitting-side variable amplification circuit 15 by using local signals LO_I and LO_Q, and generates a radio signal to be output from the antenna 3. The transmission amplification circuit 17 drives the antenna 3 based on the signal generated in the quadrature modulation circuit 16.

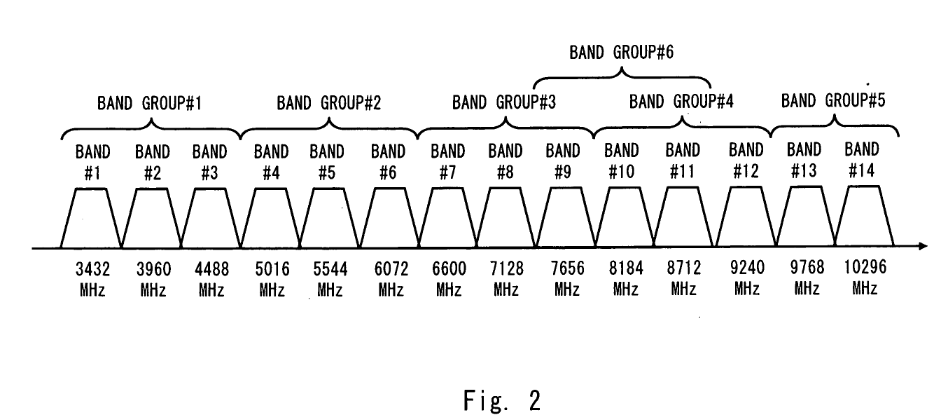

Frequency bands of radio signals that are handled in a transmitter-receiver apparatus in accordance with an exemplary embodiment of the present invention are explained hereinafter. FIG. 2 shows a schematic diagram of frequency bands of radio signals. The following explanation is made with an assumption that a transmitter-receiver apparatus in accordance with an exemplary embodiment of the present invention handles signals based on the UWB standard. In the UWB standard, signals between 3 GHz to 10 GHz are divided into 14 frequency bands and every three bands constitute one band group as shown in FIG. 2. Then, communication is carried out by selecting one band group in accordance with the channel of a radio signal and switching the communication band among three (or two) bands in the selected band group in a time-division manner. Such an action in which the band is switched in a time-division manner is called “hopping action”, and the sequence of a hopping pattern is called “hopping pattern”. Furthermore, the modulation and demodulation of a signal to be transmitted or received are carried out by quadrature modulation using a local signal having the same frequency as the radio signal in the UWB standard. Note that an assumption is made in the following explanation that the local signal generation circuit 1 generates a local signal corresponding to the band group #1, #3, and #6.

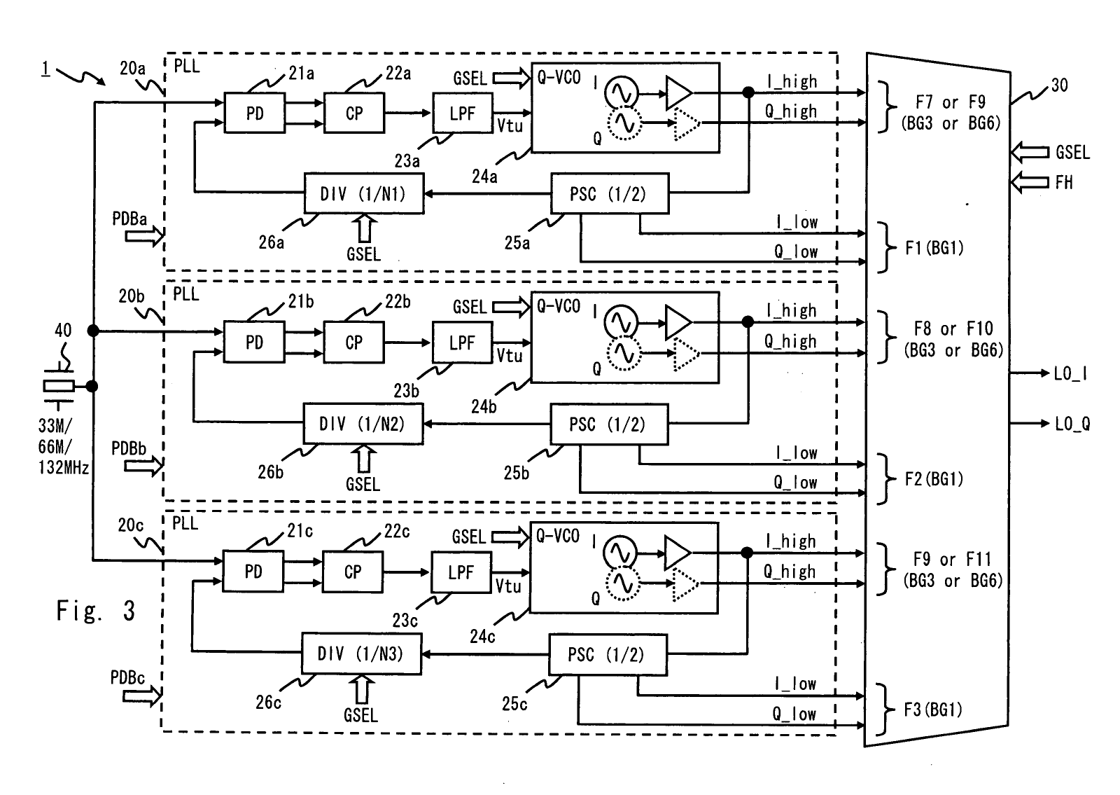

Next, details of a local signal generation circuit 1 in accordance with exemplary embodiment of the present invention are explained hereinafter. FIG. 3 shows a block diagram of a local signal generation circuit 1. Although FIG. 3 shows three PLL circuits 20a-20c and a selector 30 to select either one of the outputs of three PLL circuits 20a-20c, it is possible to construct a local signal generation circuit with a single PLL circuit if the hopping action is not required to be carried out.

The local signal generation circuit 1 shown in FIG. 3 includes PLL circuits 20a-20c, a selector 30, and a quartz oscillator 40. Each of the PLL circuits 20a-20c receives a reference signal output from the quartz oscillator 40, and outputs signals generated by multiplying the frequency of the reference signal by an even number as first output signals and second output signals. The quartz oscillator 40 generates reference signals having frequencies of, for example, 33 MHz, 66 MHz, and 132 MHz. By using a reference signal having a frequency obtained by dividing the frequency of the output signal to be output from the PLL circuit by an even number, it becomes possible to set an even number as the frequency-division ratio of the prescaler and the frequency divider within the PLL loop.

The selector 30 selects the first output signals or the second output signals, both of which are output from the PLL circuits 20a-20c, in accordance with the band group select signal GSEL, and outputs the selected signals while switching the signals to be output among the selected signals in accordance with the hopping control signal. The signals output by the selector 30 are used as local signals LO_I and LO_Q. The signals F1-F3 in the figure are signals corresponding to the bands #1-#3 in FIG. 2, and the signals F7-F11 are signals corresponding to the bands #7-#11. Furthermore, the sign BG1 indicates the signal belongs to the band group #1, the sign BG3 indicates the signal belongs to the band group #3, and the sign BG6 indicates the signal belongs to the band group #6. Note that any two given PLL circuits among the PLL circuits 20a-20c are referred to as “first PLL circuit and second PLL circuit”.

Next, details of the PLL circuits 20a-20c are explained hereinafter. Note that since the PLL circuits 20a-20c have the same configuration, only the PLL circuit 20a is explained as an example in the following explanation. Furthermore, the same components in the PLL circuits 20b and 20c as those in the PLL circuit 20a are indicated by the same numbers but suffixed with “b” or “c” instead of “a”.

The PLL circuit 20a includes a phase comparator 21a, a charge-pump circuit 22a, a loop filter 23a, a voltage control oscillator 24a, a prescaler 25a, and a frequency divider 26a. The phase comparator 21a outputs an error signal based on the phase difference between the reference signal and the feedback signal. The charge-pump circuit 22a generates a step-up voltage based on the error signal. The loop filter 23a generates a tuning voltage Vtu by changing the shape of the step-up voltage.

The voltage control oscillator 24a controls the frequency of the first output signal in accordance with the voltage value of the tuning voltage Vtu. Furthermore, the voltage control oscillator 24a shifts the frequency band of the first output signal in accordance with the band group select signal GSEL. Note that the first output signal is a signal output from the voltage control oscillator 24a. Furthermore, the first output signal output by the voltage control oscillator 24a includes a first differential signal (I_high signal) and a second differential signal (Q_high signal), which are different by 90 degrees from each other. That is, the voltage control oscillator 24a outputs four signals whose phases are different by 90 degrees from one to another.

In an exemplary embodiment of the present invention, the prescaler 25a receives a first differential signal of the first output signal and outputs a frequency-division signal generated by dividing the frequency of the first differential signal by two to the frequency divider 26a at the subsequent stage. Further, the prescaler 25a also outputs a second output signal having four phases generated by dividing the frequency of the first differential signal by two. The second output signal is a signal output from the prescaler 25a to the selector 30. Furthermore, the second output signal includes a third differential signal (I_low signal) and a fourth differential signal (Q_low signal), which are different by 90 degrees from each other. That is, the prescaler 25a outputs four signals whose phases are different by 90 degrees from one to another. Furthermore, the prescaler 25a outputs a frequency-division signal generated by dividing the frequency of a signal having a phase difference of 0 degrees (positive phase signal of the first differential signal) to the frequency divider.

The frequency-division ratio of the frequency divider 26a is set in accordance with the band group select signal GSEL. Then, it generates a feedback signal based on the set frequency-division ratio.

Note that when a stopped state is indicated by a PLL control signal PDBa, the PLL circuit 20a stops the output of the first and second output signals by cutting off the current paths in the circuit and becomes a standby state.

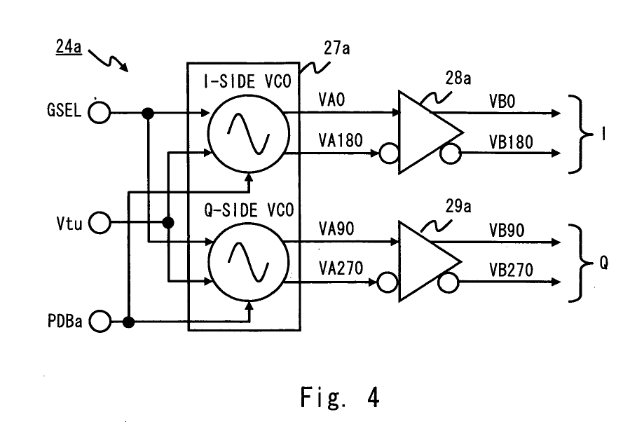

Further details of the voltage control oscillator 24a are explained hereinafter. FIG. 4 shows a block diagram of a voltage control oscillator 24a. As shown in FIG. 4, the voltage control oscillator 24a includes a voltage control oscillator 27a, and output buffers 28a and 29a. Furthermore, the voltage control oscillator 27a includes an I-side voltage control oscillator (VCO) and a Q-side voltage control oscillator (VCO). The oscillating frequencies of the I-side VCO and the Q-side VCO are both controlled by the band group select signal GSEL and the tuning voltage. Furthermore, the operation of the I-side VCO is controlled by the PLL control signal PDBa. The operation of the Q-side VCO is controlled by the PLL control signal PDBa and the band group select signal GSEL. The I-side VCO outputs a positive phase side signal VA0 and a negative phase side signal VA180 as output signals, and the Q-side VCO outputs a positive phase side signal VA90 and a negative phase side signal VA270 as output signals. Then, the positive phase side signal VA0 and the negative phase side signal VA180 become a positive phase side signal VB0 and a negative phase side signal VB180 respectively by the output buffer 28a corresponding to the differential input/differential output. Meanwhile, the positive phase side signal VA90 and the negative phase side signal VA270 become a positive phase side signal VB90 and a negative phase side signal VB270 respectively by the output buffer 29a corresponding to the differential input/differential output.

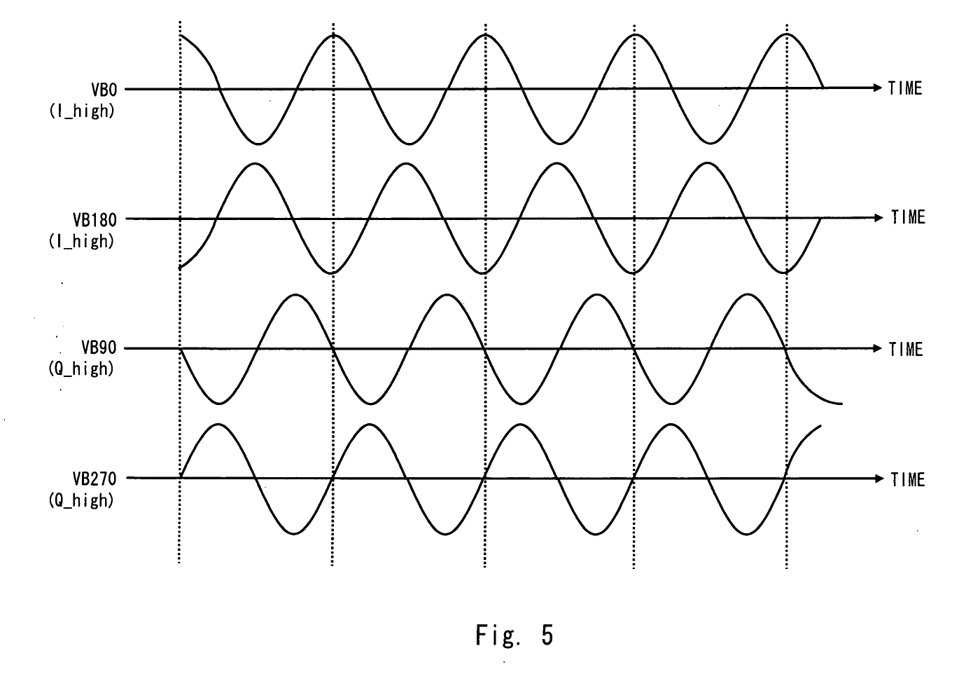

FIG. 5 shows the signal waveforms of the positive phase side signal VA0, the negative phase side signal VA180, the positive phase side signal VB90, and the negative phase side signal VB270. As shown in FIG. 5, each signal has the same frequency but a different phase. Assuming that the positive phase side signal VB0 is a reference signal, the negative phase side signal VB180 has a phase difference of 180 degrees with respect to the positive phase side signal VB0, the positive phase side signal VB90 has a phase difference of 90 degrees with respect to the positive phase side signal VB0, and the negative phase side signal VB270 has a phase difference of 270 degrees with respect to the positive phase side signal VB0. Among these signals, the positive phase side signal VB0 and the negative phase side signal VB180 constitute the first differential signal (I_high), and the positive phase side signal VB90 and the negative phase side signal VB270 constitute the first differential signal (Q_high).

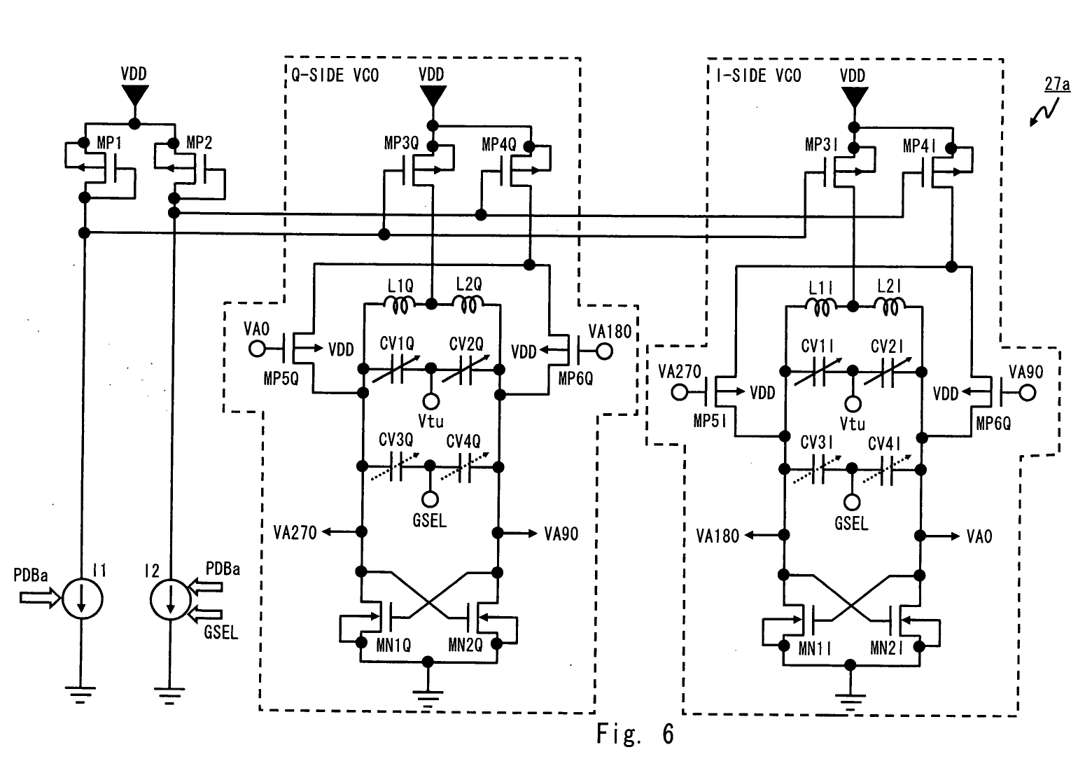

Next, details of the voltage control oscillator 27a are explained hereinafter, and how the voltage control oscillator 27a is controlled by the input control signal is also explained. FIG. 6 shows a circuit diagram of the voltage control oscillator 27a. As shown in FIG. 6, the voltage control oscillator 27a includes a Q-side VCO and an I-side VCO, current sources I1 and I2 as the current sources for these voltage control oscillators, and PMOS transistors MP1 and MP2.

The source of the PMOS transistor MP1 is connected to a power supply terminal VDD, and the gate and the drain are connected to each other. Furthermore, the current source I1 is connected between the drain of the PMOS transistor MP1 and a ground terminal. The source of the PMOS transistor MP2 is connected to the power supply terminal VDD, and the gate and the drain are connected to each other. Furthermore, the current source I2 is connected between the drain of the PMOS transistor MP2 and the ground terminal.

Since the Q-side VCO and the I-side VCO have the same configuration, the configuration of the voltage control oscillator is explained hereinafter by taking the Q-side VCO as an example. Note that the same numbers are assigned to the same components between the I-side VCO and the Q-side VCO, and the numbers in the I-side VCO are suffixed with “I” and the numbers in the Q-side VCO are suffixed with “Q” to differentiate one from the other.

The Q-side VCO includes PMOS transistors MP3Q-MP6Q, NMOS transistors MN1Q and MN2Q, inductors L1Q and L2Q, and variable capacities CV1Q-CV4Q. The source of the NMOS transistor MN1Q is connected to the ground terminal, and the gate is connected to the drain of the NMOS transistor MN2Q. The source of the NMOS transistor MN2Q is connected to the ground terminal, and the gate is connected to the drain of the NMOS transistor MN1Q. The variable capacities CV3Q and CV4Q are connected in series between the drain of the NMOS transistor MN1Q and the drain of the NMOS transistor MN2Q. Then, the band group select signal GSEL is input to the connection point of the variable capacities CV3Q and CV4Q. The variable capacities CV1Q and CV2Q are connected in series between the drain of the NMOS transistor MN1Q and the drain of the NMOS transistor MN2Q. Then, the tuning voltage Vtu is input to the connection point of the variable capacities CV1Q and CV2Q. The inductors L1Q and L2Q are connected in series between the drain of the NMOS transistor MN1Q and the drain of the NMOS transistor MN2Q. Then, the drain of the PMOS transistor MP3Q is connected to the connection point of the inductors L1Q and L2Q, so that an operating current generated at the current source I1 is supplied to that connection point. Note that the Q-side VCO generates the positive phase side signal VA90 and the negative phase side signal VA270. The positive phase side signal VA90 is output from a node connected to the drain of the NMOS transistor MN2Q, and the negative phase side signal VA270 is output from a node connected to the drain of the NMOS transistor MN1Q.

The drain of the PMOS transistor MP5Q is connected to the drain of the NMOS transistor MN1Q, and the positive phase side signal VA0 that is generated in the I-side VCO is input to the gate of the PMOS transistor MP5Q. The drain of the PMOS transistor MP6Q is connected to the drain of the NMOS transistor MN2Q, and the negative phase side signal VA180 that is generated in the I-side VCO is input to the gate of the PMOS transistor MP6Q. Furthermore, the drain of the PMOS transistor MP5Q and the drain of the PMOS transistor MP6Q are connected in common. The drain of the PMOS transistor MP4Q is connected to this common connection point, so that an operating current generated at the current source I2 is supplied to that common connection point. Note that the I-side VCO generates the positive phase side signal VA0 and the negative phase side signal VA180. The positive phase side signal VA0 is output from a node connected to the drain of the NMOS transistor MN2I, and the negative phase side signal VA180 is output from a node connected to the drain of the NMOS transistor MN1I. Furthermore, the negative phase side signal VA270 is input to the PMOS transistor MP5I, and the positive phase side signal VA90 is input to the PMOS transistor MP6I in the I-side VCO.

The source of the PMOS transistor MP3Q is connected to the power supply terminal VDD, and the gate of the PMOS transistor MP3Q and the gate of the PMOS transistor MP1 are connected in common. That is, the PMOS transistor MP3Q constitutes a current mirror circuit with the PMOS transistor MP1, and supplies the operating current generated by the current source I1 to the Q-side VCO. The source of the PMOS transistor MP4Q is connected to the power supply terminal VDD, and the gate of the PMOS transistor MP4Q and the gate of the PMOS transistor MP2 are connected in common. That is, the PMOS transistor MP4Q constitutes a current mirror circuit with the PMOS transistor MP2, and supplies the operating current generated by the current source I2 to the Q-side VCO.

The above-described voltage control oscillator 27a changes the capacitance values of the variable capacities CV3Q, CV4Q, CV3I, and CV4I in a discrete manner in accordance with the band group select signal GSEL that is provided as a bus control signal. When the band group select signal GSEL indicates such a control that a higher band group is selected, the band group select signal GSEL takes on a voltage value that makes the capacitance values of the variable capacities CV3Q, CV4Q, CV3I, and CV4I smaller. In this way, the frequency band of the output signal from the voltage control oscillator 27a is switched to a high-frequency side. On the other hand, when the band group select signal GSEL indicates such a control that a lower band group is selected, the band group select signal GSEL takes on a voltage value that makes the capacitance values of the variable capacities CV3Q, CV4Q, CV3I, and CV4I larger. In this way, the frequency band of the output signal from the voltage control oscillator 27a is switched to a low-frequency side. Furthermore, a fine adjustment is carried out for the oscillating frequency by adjusting the capacitance values of the variable capacities CV1Q, CV2Q, CV1I, and CV2I with the voltage value of the tuning voltage Vtu. The PLL control signal PDBa is input to the current source I1, so that when the PLL control signal PDBa indicates the suspension of the operation, the current output is suspended. In this way, one of the operating currents supplied to the Q-side VCO and the I-side VCO is cut off. Furthermore, the PLL control signal PDBa and the band group select signal GSEL are input to the current source I2, so that when at least one of the PLL control signal PDBa and the band group select signal GSEL indicates the suspension of the operation, the current output is suspended. In this way, one of the operating currents supplied to the Q-side VCO and the I-side VCO is cut off. At this point, when the current source I2 is suspended, the differential pair composed of the PMOS transistors MP5Q and MP6Q and the differential pair composed of PMOS transistors MP5I and MP6I are stopped, and therefore the voltage control oscillator 27a outputs only one differential signal (e.g., first differential signal). In an exemplary embodiment of the present invention, when the band group #1 is selected by the band group select signal GSEL, it enters the mode in which only the current source I2 is suspended, so that the power consumption of the voltage control oscillator 24a is reduced.

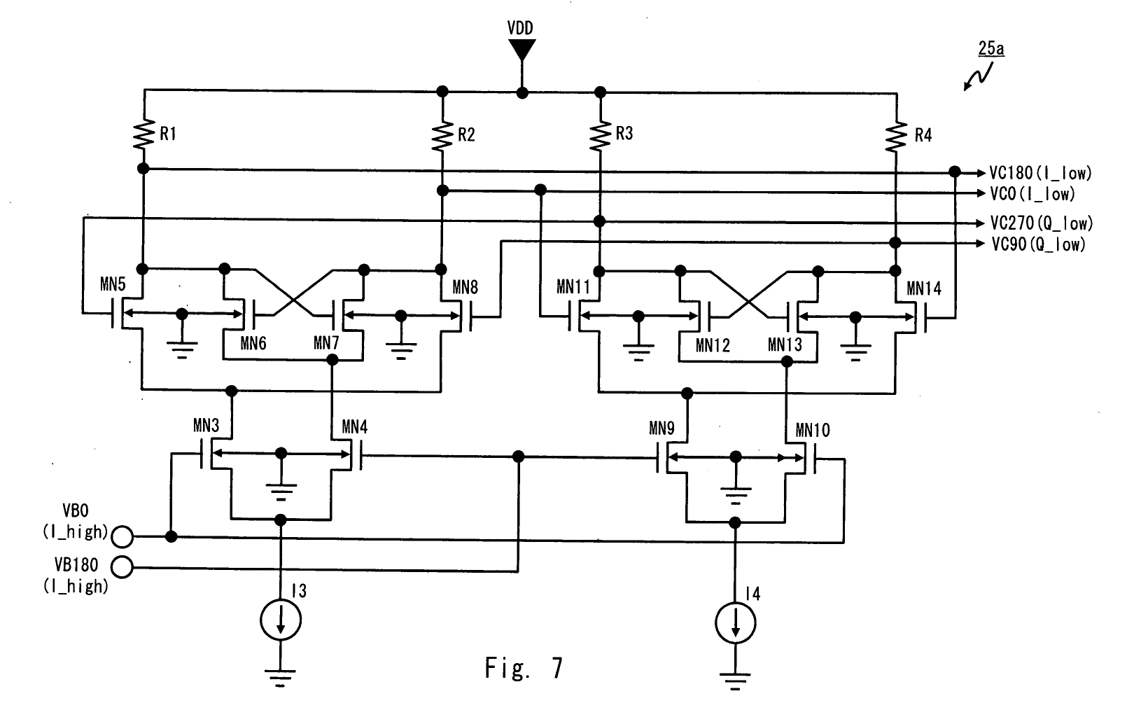

Next, the circuit and the operation of the prescaler 25a are explained hereinafter. FIG. 7 shows a circuit diagram of the prescaler 25a. As shown in FIG. 7, the prescaler 25a includes current sources I3 and I4, NMOS transistors MN3-MN14, and resistors R1-R4.

The NMOS transistors MN3 and MN4 constitute a differential pair, and the current source I3 is connected between their common connection point on the source side and a ground terminal. The positive phase side signal VB0 is input to the gate of the NMOS transistor MN3, and the negative phase side signal VB180 is input to the gate of the NMOS transistor MN4. The NMOS transistors MN5 and MN8 constitute a differential pair, and their common connection point on the source side is connected to the drain of the NMOS transistor MN3. The gate of the NMOS transistor MN5 is connected to the drain of the NMOS transistor MN11, and the gate of the NMOS transistor MN8 is connected to the drain of the NMOS transistor MN14. Furthermore, the resister R1 is connected between the drain of the NMOS transistor MN5 and a power supply terminal VDD, and a negative phase side signal VC180 of a third differential signal is output from the connection point of the drain of the NMOS transistor MN5 and the resister R1. The resister R2 is connected between the drain of the NMOS transistor MN8 and the power supply terminal VDD, and a positive phase side signal VC0 of the third differential signal is output from the connection point of the drain of the NMOS transistor MN8 and the resister R2. The NMOS transistors MN6 and MN7 constitute a differential pair, and their common connection point on the source side is connected to the drain of the NMOS transistor MN4. The gate of the NMOS transistor MN6 is connected to the drains of the NMOS transistor MN7 and the NMOS transistor MN8. The gate of the NMOS transistor MN7 is connected to the drains of the NMOS transistor MN6 and the NMOS transistor MN5.

The NMOS transistors MN9 and MN10 constitute a differential pair, and the current source I4 is connected between their common connection point on the source side and the ground terminal. The negative phase side signal VB180 is input to the gate of the NMOS transistor MN9, and the positive phase side signal VB0 is input to the gate of the NMOS transistor MN10. The NMOS transistors MN11 and MN14 constitute a differential pair, and their common connection point on the source side is connected to the drain of the NMOS transistor MN9. The gate of the NMOS transistor MN11 is connected to the drain of the NMOS transistor MN8, and the gate of the NMOS transistor MN14 is connected to the drain of the NMOS transistor MN5. Furthermore, the resister R3 is connected between the drain of the NMOS transistor MN11 and the power supply terminal VDD, and a negative phase side signal VC270 of a fourth differential signal is output from the connection point of the drain of the NMOS transistor MN11 and the resister R3. The resister R4 is connected between the drain of the NMOS transistor MN14 and the power supply terminal VDD, and a positive phase side signal VC90 of the fourth differential signal is output from the connection point of the drain of the NMOS transistor MN14 and the resister R4. The NMOS transistors MN12 and MN13 constitute a differential pair, and their common connection point on the source side is connected to the drain of the NMOS transistor MN10. The gate of the NMOS transistor MN12 is connected to the drains of the NMOS transistor MN13 and the NMOS transistor MN14. The gate of the NMOS transistor MN13 is connected to the drains of the NMOS transistor MN12 and the NMOS transistor MN11.

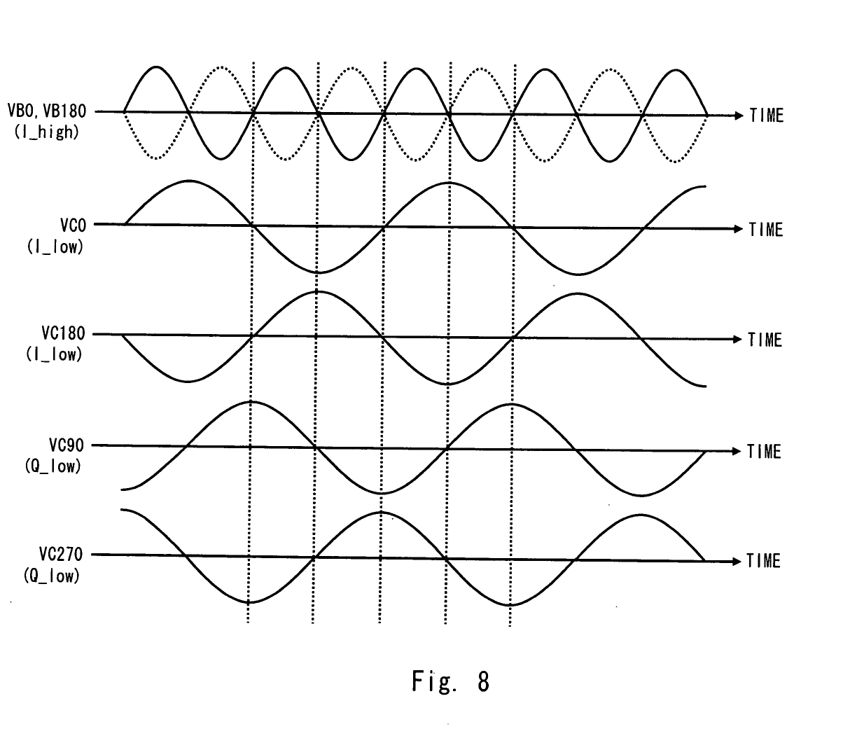

FIG. 8 shows waveforms of the input signals and the output signals of the prescaler 25a, and the operation of the prescaler 25a is explained hereinafter. As shown in FIG. 8, the frequency of the output differential signals VC0, VC90, VC180, and VC270 is halved with respect to the input first differential signals (VB0 and VB180) in the prescaler 25a. That is, the prescaler 25a works as a ½ frequency divider. Furthermore, assuming that the positive phase side signal VC0 of the third differential signal is a reference signal, the negative phase side signal VC180 of the third differential signal has a phase difference of 180 degrees, the positive phase side signal VC90 of the fourth differential signal has a phase difference of 90 degrees, and the negative phase side signal VC270 of the fourth differential signal has a phase difference of 270 degrees. That is, the prescaler 25a outputs four signals whose phases are different from one to another.

The operation of the local signal generation circuit 1 is explained hereinafter. Firstly, a band group to be output is selected by the band group select signal GSEL in the local signal generation circuit 1. The frequency of a first output signal output by the PLL circuits 20a-20c is determined by this band group selection.

For example, if the band group #3 is selected, a first output signal having the center frequency of 6600 MHz is generated in the PLL circuit 20a, a first output signal having the center frequency of 7128 MHz is generated in the PLL circuit 20b, and a first output signal having the center frequency of 7656 MHz is generated in the PLL circuit 20c. Then, the selector 30 successively selects first output signals to be output by the voltage control oscillators 24a-24c of the PLL circuits 20a-20c at timing indicated by the hopping control signal, and outputs the selected first output signals.

Furthermore, if the band group #3 is selected, a first output signal having a frequency as twice high as the center frequency of the band #1, i.e., frequency of 6864 MHz is generated in the voltage control oscillator 24a of the PLL circuit 20a, a first output signal having a frequency as twice high as the center frequency of the band #2, i.e., frequency of 7920 MHz is generated in the voltage control oscillator 24b of the PLL circuit 20b, and a first output signal having a frequency as twice high as the center frequency of the band #3, i.e., frequency of 8976 MHz is generated in the voltage control oscillator 24c of the PLL circuit 20c. Furthermore, the PLL circuits 20a-20c also output, by using the prescalers 25a-25c, second output signals by dividing the frequencies of first output signals generated at the voltage control oscillators 24a-24c. Then, the selector 30 successively selects a second output signal to be output by the prescalers 25a-25c of the PLL circuits 20a-20c at timing indicated by the hopping control signal, and outputs the selected second output signal. At this point, the current source I2 of the Q-side VCO, which is not used as the input signals to the prescalers 25a-25c, is suspended in the voltage control oscillators 24a-24c, so that the power consumption is reduced.

Furthermore, when the hopping pattern indicates that the hopping action is not carried out or is carried out between only two frequencies in the local signal generation circuit 1, the power consumption is reduced by cutting off the current paths for the unused PLL circuits with the PLL control signal PDB.

As can been seen from the above explanation, a local signal generation circuit 1 in accordance with an exemplary embodiment of the present invention generates the low-frequency side output signal (second output signal) by using the prescalers 25a-25c within the PLL loops. In this way, the local signal generation circuit 1 can generates the low-frequency side output signal without providing a frequency divider outside of the PLL loop. That is, the local signal generation circuit 1 can generates the low-frequency side output signal by the prescaler included in the PLL loop even if the voltage control oscillator has only a generating function for the high-frequency side signal. Furthermore, the local signal generation circuit 1 can generates an output signal having low phase noise by limiting the output frequency of the voltage control oscillator. For example, in the case of covering the band groups #1, #3, and #6, it is preferable to restrict the frequency range ratio covered by the voltage control oscillator to the order of 11% (792 MHz/6864 MHz) in order to generate such an output signal having low phase noise.

Furthermore, when a low-frequency side output signal is output as a local signal in a local signal generation circuit 1 in accordance with an exemplary embodiment of the present invention, the current source I2, which is used to generate the second differential signal in the voltage control oscillator, is stopped. Therefore, the local signal generation circuit 1 can reduce unnecessary power consumption. Furthermore, the local signal generation circuit 1 can suspend unused PLL circuits by the PLL control signal PDB when the hopping action is not carried out or is carried out between only two frequencies by the hopping pattern. Therefore, the local signal generation circuit 1 can carry out the reduction in the power consumption in accordance with the hopping pattern.

In the above-described exemplary embodiments, a local signal generation circuit 1 that carries out a hopping action with three PLL circuits is explained. When a local signal generation circuit 1 has several PLL circuits as with the above exemplary embodiments, the effect of reducing the circuit area and the power consumption becomes more prominent by using a PLL circuit in accordance one aspect of the present invention for each of the PLL circuits.

Note that the present invention is not limited to the above-described exemplary embodiment, and modifications can be made without departing from the spirit of the present invention. For example, the voltage control oscillator is not limited to those of the above exemplary embodiments, and it can be modified as appropriate in accordance with the circuit structure.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A local signal generation circuit comprising:
a phase comparator that detects a phase difference between a reference signal and a feedback signal and outputs a error signal;
a charge-pump circuit that receives the error signal and generates a step-up voltage;
a loop filter that generates a tuning voltage by changing the shape of the step-up voltage;
a voltage control oscillator that generates a first output signal having a predefined frequency based on the tuning voltage; and
a prescaler that outputs a second output signal generated by dividing the frequency of the first output signal to a predefined frequency and also outputs a frequency-division signal generated by dividing the frequency of the first output signal to the predefined frequency to a frequency divider, the frequency divider generating the feedback signal.

2. The local signal generation circuit according to claim 1, wherein the first output signal has a frequency of an even multiple of the reference signal.

3. The local signal generation circuit according to claim 1, wherein the second output signal has a frequency of a half of the first output signal.

4. The local signal generation circuit according to claim 1, wherein:
the first output signal includes a first differential signal and a second differential signal, the phases of the first and second differential signals being different by 90 degrees from each other;
the prescaler receives either one of the first differential signal and the second differential signal; and
the second output signal includes a third differential signal and a fourth differential signal, the phases of the third and fourth differential signals being different by 90 degrees from each other.

5. The local signal generation circuit according to claim 1, wherein:
the local signal generation circuit comprises a first control circuit that generates a band group select signal indicating the frequency band of a signal to be generated; and
the voltage control oscillator changes the frequency of the first output signal based on the band group select signal.

6. The local signal generation circuit according to claim 5, wherein when an output of a low-frequency side signal is indicated based on the band group select signal, an oscillator to generate a signal that is not input to the prescaler is suspended.

7. The local signal generation circuit according to claim 1, further comprising:
a first PLL circuit and a second PLL circuit, the first PLL circuit and the second PLL circuit being formed by the local signal generation circuit;
a second control circuit that outputs a hopping control signal in accordance with a hopping pattern indicating a switching pattern of the output signal of the first PLL circuit and the output signal of the second PLL circuit; and
an output select circuit that outputs the outputs of the first and second PLL circuits while switching the signal to be output between the output signal of the first PLL circuit and the output signal of the second PLL circuit in accordance with the hopping control signal.

8. The local signal generation circuit according to claim 7, further comprising a third control circuit that outputs a PLL control signal designating an unnecessary PLL circuit based on the hopping pattern,
wherein the operations of the first and second PLL circuits are suspended based on the PLL control signal.
